(19) United States
(12) Patent Application Publication
(10) Pub. No.: US 2026/0301063 A1
(43) Pub. Date: Oct. 1, 2026

(54) METHOD AND SYSTEM FOR MACHINE-LEARNING REAL - TIME ANALYSIS OF USER ENTITY ASSETS

(71) Applicant: Chris Leyva, Sparks, NV (US)

(72) Inventor: Chris Leyva, Sparks, NV (US)

(21) Appl. No.: 19/089,570

(22) Filed: Mar. 25, 2025

(51) Int. Cl. G06Q 40/03; G06Q 20/06

(52) U.S. Cl. CPC G06Q 40/03; G06Q 20/065

(57) ABSTRACT

A system for real-time analysis and generation of a predictive verdict for a user entity based on user entity blockchain assets may be configured to onboard a target user associated with the at least one user-entity node on a permissioned blockchain responsive to an approval request comprising user financial data received from at least one user-entity node; derive parameters from the target user financial data based on the request; record the parameters on the permissioned blockchain in a form of target user assets; generate a feature vector based on the target user assets; ingest the feature vector into the ML module coupled to an Artificial Neural Network (ANN); receive a plurality of approval parameters from at least one financial predictive model generated by the ML module using outputs of the ANN based on the feature vector; and generate at least one verdict for the at least one user entity node.

### FIELD OF DISCLOSURE

The present disclosure generally relates to loan analytics applications, and more particularly, to a system and method for an automated real-time analysis and generation of predictive loan repayment, application, and contract generation based on loan application data.

### BACKGROUND

Automation of financial data analysis has become a critical tool in assessing the creditworthiness of borrowers. Traditional credit risk evaluation methods often rely on historical data, such as credit scores, income history, and past loan repayment records. While these methods provide valuable insights, they fail to account for real-time loan application behavior and dynamic borrower activity, which can more accurately reflect a borrower's current capacity to repay new loans.

Current systems generally depend on static financial data, such as a borrower's credit report or historical loan performance, to predict future behavior. However, these systems do not adapt quickly enough to changes in a borrower's circumstances, such as the submission of new loan applications, fluctuations in loan approval rates, or recent changes in loan terms and conditions.

Some existing technologies aim to evaluate creditworthiness using historical financial data or transactional analysis. For example, certain systems focus on analyzing credit reports, income history, and past loan repayment records. While these systems offer insights into a borrower's historical financial behavior, they do not incorporate real-time loan application data or behavioral patterns that provide a more accurate and adaptive view of a borrower's current financial capacity and ability to repay additional loans.

Other technologies, such as machine learning systems used in various recommendation engines, analyze patterns from past behaviors to make predictions. For instance, some systems use machine learning to rank or recommend products based on consumer behavior and preferences. While these systems excel at predicting purchasing behavior, they do not focus on loan application submission patterns or offer a real-time analysis of a borrower's creditworthiness. These methods fail to capture the dynamic nature of a borrower's financial situation, which may be critical for accurately assessing loan repayment capability.

Conventional systems, such as those used by financial institutions to process loan applications, analyze individual data points but fail to integrate multiple loan applications over time into a holistic view of a borrower's current financial situation. These systems may offer limited predictive insights by examining static data, without leveraging real-time application data to assess whether a borrower can afford new credit.

As a result, there remains a need for a comprehensive system that analyzes loan applications in real-time, evaluates the borrower's ability to repay based on their loan application history, and uses machine learning to generate accurate, adaptive creditworthiness outlooks.

The system disclosed herein addresses these limitations by utilizing real-time loan application data, predictive analytics, and machine learning to create an accurate, up-to-date profile of a borrower's repayment capacity. This system allows lenders to make more informed decisions by considering current loan behaviors rather than relying solely on past data or static credit scores.

Therefore, a method and system that use real-time loan application data and machine learning to predict borrower repayment capabilities and improve the accuracy of creditworthiness assessments may be required.

### BRIEF OVERVIEW

This brief overview may be provided to introduce a selection of concepts in a simplified form that may be further described below in the Detailed Description. This brief overview may not be intended to identify key features or essential features of the claimed subject matter. Nor may be this brief overview intended to be used to limit the claimed subject matter's scope.

One aspect of the disclosed system is an automated real-time analysis platform that generates predictive verdicts for a user entity based on blockchain-recorded assets. The system includes an asset analysis server (AAS) node equipped with a machine learning (ML) module, which interacts with a user-entity node and multiple remote nodes over a permissioned blockchain network. This system dynamically evaluates a user entity's financial standing by leveraging real-time blockchain-stored asset data, offering a more adaptive and secure approach to predictive financial analysis than conventional methods that rely solely on historical credit reports.

In one embodiment, the system's processor executes machine-readable instructions that enable the onboarding of a target user to a permissioned blockchain following an approval request that includes user financial data. Upon approval, the system derives financial parameters from the request, records them as blockchain-based target user assets, and generates a feature vector representing the user's financial profile. Generated feature vectors may be processed by an ML module integrated with an Artificial Neural Network (ANN), which extracts predictive insights based on blockchain-stored assets rather than conventional credit history. The ML module applies at least one financial predictive model to evaluate user-specific approval parameters, which are then used to determine a predictive verdict regarding the user's financial standing.

Another aspect of the disclosed system provides a method for conducting automated, real-time financial assessments using blockchain-stored user entity assets. The method involves acquiring and analyzing permissioned blockchain data, dynamically generating predictive verdicts based on machine-learning models, and offering financial institutions an alternative to traditional credit assessment techniques. By focusing on current user activity rather than outdated financial records, this approach ensures a more accurate and transparent evaluation process.

The disclosed system and method differ from existing financial analysis technologies by leveraging blockchain-recorded asset data and integrating an ML-based predictive model. Unlike traditional credit scoring models, which primarily rely on historical financial records, this system utilizes a permissioned blockchain to maintain real-time financial asset tracking. By incorporating a machine-learning module with ANN-based analysis, the system enhances predictive accuracy, offering a more adaptable and decentralized method for evaluating user financial standing in real time.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a method for machine learning-based real-time analysis of loan application data with blockchain integration, according to some embodiments;

FIG. 4 illustrates a block diagram for machine learning-based real-time analysis of loan application data with blockchain integration, according to some embodiments;

FIG. 5 illustrates deployment of a machine learning model for prediction of the approval verdict parameters using blockchain assets, according to some embodiments; and

FIGS. 6-9 illustrate example scenarios of a machine learning model for prediction of the approval verdict parameters using blockchain assets, according to some embodiments.

### DETAILED DESCRIPTION

The specific details of the single embodiment or variety of embodiments described herein may be set forth in this application. Any specific details of the embodiments described herein may be used for demonstration purposes only, and no unnecessary limitation(s) or inference(s) may be to be understood or imputed therefrom.

Before describing exemplary embodiments in detail, it may be noted that the embodiments reside primarily in combinations of components related to devices and systems. Accordingly, the device components have been represented where appropriate by conventional symbols in the drawings, showing only those specific details that may be pertinent to understanding the embodiments of the present disclosure so as not to obscure the disclosure with details that will be readily apparent to those of ordinary skill in the art having the benefit of the description herein.

The disclosed system provides an automated, real-time analysis and generation of predictive loan application outlooks based on loan application data. By leveraging an asset analysis server(AAS) node configured with a machine learning (ML) module, the system integrates data from a target loan application and multiple remote nodes. The AAS node employs an artificial neural network (ANN) to process and analyze loan application activity, deriving approval verdict parameters that contribute to a loan application's creditworthiness outlook. Unlike traditional static credit evaluation models, which rely solely on past financial behavior, the disclosed system dynamically adapts to real-time loan application behavior, ensuring a comprehensive and up-to-date assessment of financial capacity.

The AAS node comprises a processor and a memory, which stores machine-readable instructions that, when executed, direct the system to acquire target loan application data. This acquisition process involves communicating with financial institution APIs, loan origination systems, and third-party credit assessment platforms. APIs (Application Programming Interfaces) act as digital pipelines, allowing different systems to exchange structured and unstructured data seamlessly. The acquired data includes key action metrics such as loan application frequency, approval rates, loan amounts, terms, and behavioral indicators, which serve as fundamental variables for predicting financial stability and borrowing behavior.

The system performs normalization of the target loan application data to ensure consistency across different data sources and loan products. Normalization may be a data pre-processing technique that standardizes data formats, corrects discrepancies, and removes biases. This process includes data type standardization (ensuring dates, currency amounts, and numerical values follow a consistent format), filling in missing values using statistical methods (such as mean imputation), and detecting outliers using interquartile range (IQR) and Z-score analysis. By normalizing data, the system ensures that all inputs may be comparable and suitable for predictive modeling.

Once normalized, the data may be parsed using natural language processing (NLP) and statistical parsing techniques to extract meaningful attributes. NLP enables the system to interpret unstructured text data, such as loan terms described in applications, while statistical parsing organizes numerical and categorical data into structured formats. Feature engineering algorithms, including principal component analysis (PCA) and recursive feature elimination (RFE), may be applied to identify the most significant features contributing to creditworthiness predictions. Examples of these features include repayment history, loan stacking behavior (simultaneous borrowing from multiple sources), and financial stability relative to industry standards.

A feature vector may be generated based on the extracted classifying features. A feature vector may be a structured numerical representation of data points that can be processed by machine learning models. Vectorization techniques such as term frequency-inverse document frequency (TF-IDF) may be used to quantify text-based data, while categorical data may be converted using one-hot encoding (a method that converts categorical labels into binary values). The feature vector may be then standardized and scaled using min-max normalization (rescaling values between 0 and 1) or z-score normalization (centering the data around the mean), ensuring that all input features contribute proportionally to the final prediction.

The ML module employs a deep learning ANN trained on historical and real-time loan application data. An ANN may be a computing system inspired by the human brain, consisting of multiple interconnected layers of nodes (neurons). Each hidden layer in the ANN applies activation functions such as ReLU (Rectified Linear Unit) or sigmoid, which help the model capture non-linear relationships in data. The feature vector may be fed into the ANN, where forward propagation computes weighted sums, and backpropagation refines these weights through gradient descent optimization. This iterative process allows the ANN to learn complex patterns and associations between input features and credit risk indicators.

The approval verdict parameters generated by the ANN include key financial indicators such as probability of default, credit risk exposure, and estimated repayment likelihood. These parameters may be used to compute a loan application's creditworthiness outlook, which may be updated dynamically as new loan application data may be received. The system ensures real-time analysis by continuously monitoring incoming data streams and identifying deviations from historical patterns. A statistical drift detection mechanism, such as the Kolmogorov-Smirnov test, may be implemented to compare new data distributions with historical baselines. If significant changes may be detected, an updated feature vector may be generated, prompting recalibration of the predictive outlook model.

The disclosed system enhances financial decision-making by generating a target loan application report. This report contains approval verdict parameters, related recommendations, and a loan approval predicted verdict. To ensure data integrity and transparency, the report may be securely stored on a permissioned blockchain ledger. Blockchain technology employs cryptographic hashing and distributed consensus mechanisms to prevent data tampering. The system enables blockchain-based retrieval of approval verdict parameters, requiring consensus among the target loan application, AAS node, and associated remote nodes before accessing sensitive data. In embodiments, the system continuously determines, updates, and stores approval verdict parameters and target loan application reports in real-time on the permissioned blockchain ledger.

Additionally, the system supports the execution of smart contracts to generate non-fungible tokens (NFTs) representing target loan application outlook reports. Smart contracts may be self-executing agreements that trigger predefined actions when conditions may be met. By tokenizing outlook reports as NFTs, the system ensures an immutable and verifiable record of a loan application's creditworthiness, which can be accessed by authorized parties in decentralized financial ecosystems.

The disclosed method may incorporate anonymized data sharing to help financial institutions assess the true economic capacity of a loan application without compromising privacy. Anonymized data undergoes de-identification techniques, such as data masking and differential privacy, ensuring that individual borrowers cannot be re-identified while still allowing meaningful insights into borrowing trends.

The system's architecture provides a comprehensive 360-degree view of a target loan application's financial standing by aggregating real-time loan applications, existing credit obligations, approval rates, and repayment behaviors. By integrating AI-driven analytics with permissioned blockchain storage, the disclosed system delivers a robust, adaptive framework for predictive credit assessment that may be transparent, secure, and continuously evolving with financial trends.

Various implementations of the invention involve the technical field of real-time analysis and generation of predictive loan repayment outlook, application, and contract generation based on loan application data including a processor of an asset analysis server (AAS) node configured to host a machine learning (ML) module coupled to at least one target user-loan application node and to a plurality of remote nodes associated with the at least one target loan application node over a network; and a memory on which may be stored machine-readable instructions that, when executed by the processor, cause the processor to: acquire target loan application data from the at least one target loan application node, the target loan application data comprising action metrics associated with loan applications submitted by the target loan application and the plurality of remote nodes related to the target loan application; perform normalization of the target loan application data based on the action metrics; parse the normalized data to derive a plurality of classifying features; generate a feature vector based on the plurality of classifying features; ingest the feature vector into the ML module coupled to an Artificial Neural Network (ANN); receive a plurality of approval verdict parameters from at least one loan application outlook predictive model generated by the ML module using outputs of the ANN based on the feature vector; and generate at least one report for the at least one loan application node based on the plurality of approval verdict parameters, and may be therefore necessarily rooted in computer technology. For example, the aforementioned steps may be inherently computer-based and cannot be performed in the human mind. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product may be impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

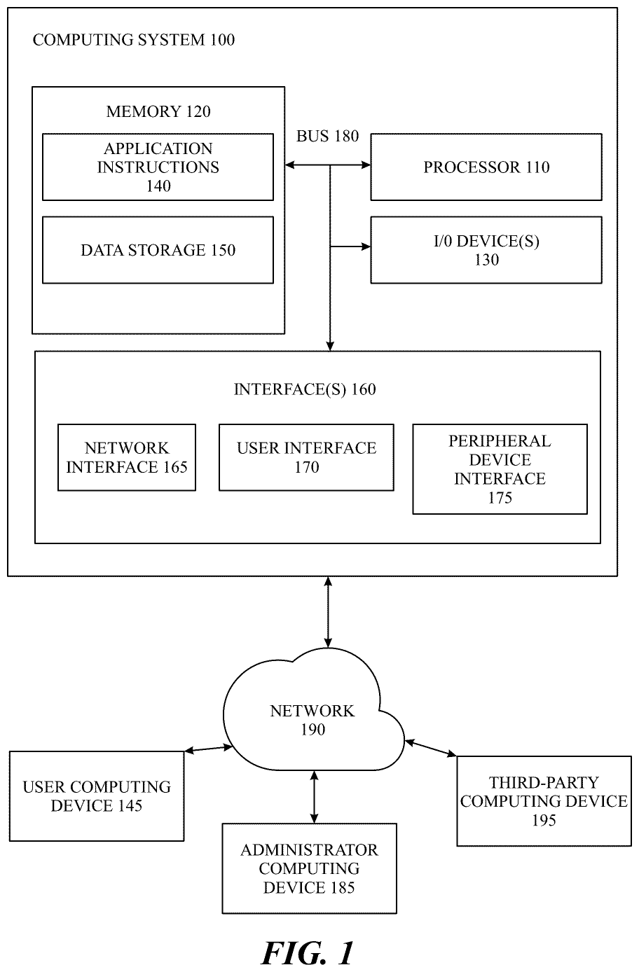

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) may be in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component may be utilized to refer to “memory components,” which may be entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium may be not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 may be configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 may be selected based on the proximity of the devices to one another or some other factor. For example, when a first user device and second user device may be near each other (e.g., within a threshold distance, within direct communication range, etc.), the first user device may exchange data using a direct peer-to-peer network. But when the first user device and the second user device may be not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software may be transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system may be world-wide-web (www) based, and the network server may be a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on may be developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 may be utilized by an administrative user to moderate content and to perform other administrative functions. The third-party computing device 195 may be utilized by third parties to receive communications from the user computing device, transmit communications to the user via the network, and otherwise interact with the various functionalities of the system.

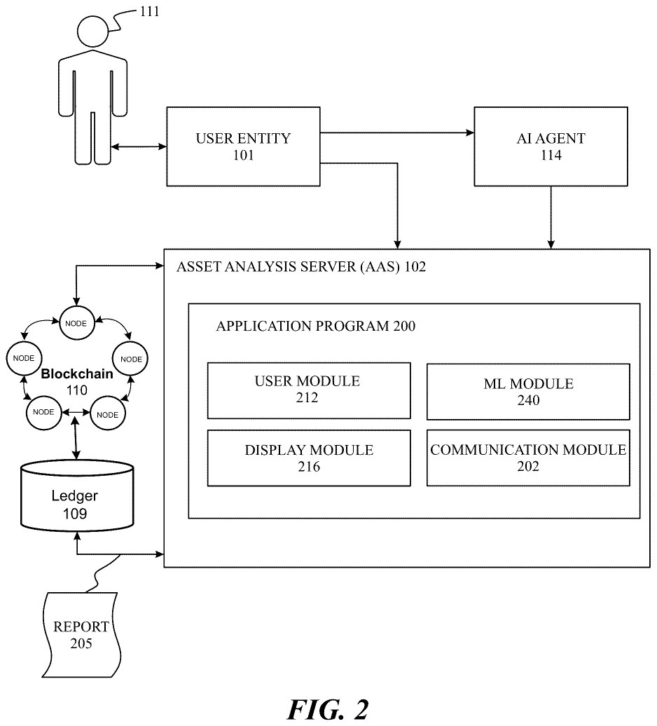

FIG. 2 illustrates an example computer architecture for the application program 200 operated via the computing system 100. The computer system 100 comprises several modules and engines configured to execute the functionalities of the application program 200. In particular, FIG. 2 may be a block diagram showing the modules and engines needed to perform specific tasks within the application program 200.

Referring to FIG. 2, an asset analysis server (AAS) 102, corresponding to the computing system 100 of FIG. 1, operating the application program 200 comprises one or more modules having the necessary routines and data structures for performing specific tasks, and one or more engines configured to determine how the platform manages and manipulates data. In some embodiments, the application program 200 comprises one or more of an ML module 240, a communication module 202, a user module 212, and a display module 216.

In some embodiments, the AAS 102 and ML module 240 are configured to communicate with each other, facilitating the integration of data from a target loan application and multiple remote nodes. The system utilizes an ANN to process and evaluate loan application activity, generating approval verdict parameters that contribute to a loan application's creditworthiness assessment and report 205. The AAS 102 node includes a processor and a memory, which contains machine-readable instructions that, when executed, enable the system to collect loan application data for a target loan application. This data acquisition process involves interfacing with financial institution APIs, loan origination platforms, and third-party credit assessment services. APIs (Application Programming Interfaces) function as digital conduits, enabling seamless exchange of structured and unstructured data across different systems. The acquired data encompasses key action metrics such as loan application frequency, approval rates, loan amounts, terms, and behavioral indicators, all of which are critical for assessing financial stability and borrowing behavior. The ML module 240 employs a deep learning ANN trained on both historical and real-time loan application data. An ANN, modeled after neural networks in the human brain, consists of multiple interconnected layers of nodes. Within the ANN, each hidden layer utilizes activation functions like RELU or sigmoid, allowing the model to recognize complex, non-linear patterns in the data. The feature vector is input into the ANN, where forward propagation calculates weighted sums, while backpropagation refines these weights using gradient descent optimization. Through this iterative process, the ANN learns intricate relationships between input features and credit risk indicators, improving the accuracy of predictive analysis and report 205 generation.

In some embodiments, the communication module 202 may be configured for receiving, processing, and transmitting a user command and/or one or more data streams. In such embodiments, the communication module 202 performs communication functions between various devices, including the user entity 101, the user computing device 145 of FIG. 1, the administrator computing device 185 of FIG. 1, and a third-party computing device 195 of FIG. 1. In some embodiments, the communication module 202 may be configured to allow one or more users of the system, including a third-party, to communicate with one another. In some embodiments, the communications module 202 may be configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

The user module 212 may store user preferences including the user account information, historical usage data, user personal information, and the like. The user module 212 may facilitate the creation of user's profiles for users, administrators, and others.

In some embodiments, the display module 216 may be configured to display one or more graphic user interfaces, including, e.g., one or more user interfaces. In some embodiments, the display module 216 may be configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

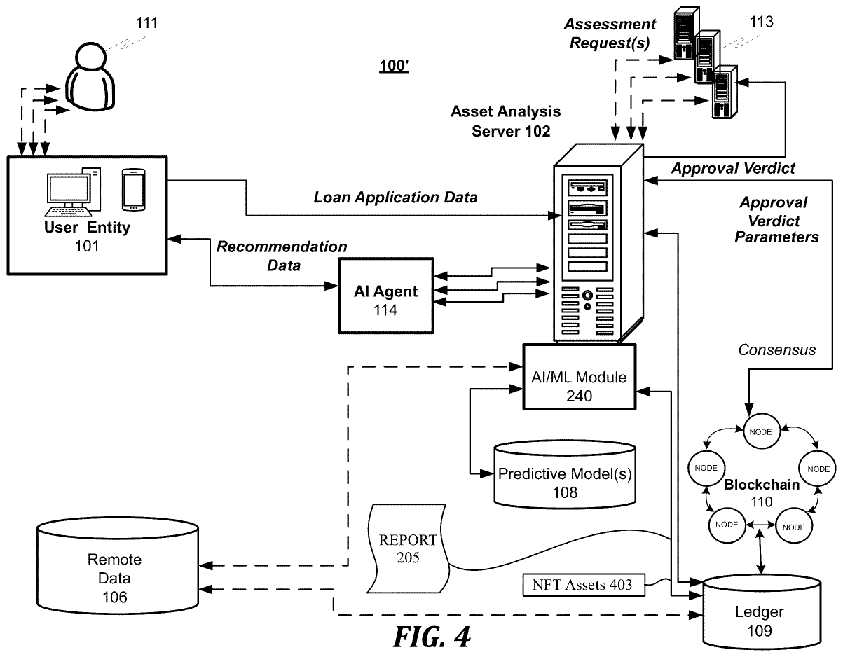

In another embodiment, the computing system 100 can capture conversation data (e.g., call logs, audio, or textual exchanges) of a user 111 from a user entity 101 related to interactions between the user loan application, associated with user 111, and an AI agent 114. The AI agent 114 may function as a chatbot, supported by the AI/ML module 240 of the computing system 100. The captured conversation data may include language identifier metadata, indicating the language used by user 111 while communicating with the AI agent 114. The disclosed system improves financial decision-making by generating a target loan application report 205 with approval verdict parameters, recommendations, and a predicted verdict. This report can be securely stored on a permissioned blockchain ledger, ensuring data integrity through cryptographic hashing and distributed consensus. The system enables blockchain-based retrieval of approval verdict parameters, requiring consensus among the loan application, AAS node, and remote nodes before accessing sensitive data. It continuously updates and stores approval verdict parameters and reports 205 in real-time on the blockchain ledger. In one embodiment, the computing system 100 may obtain loan application data for analysis purposes from a permissioned blockchain 110 ledger 109. This occurs based on a consensus among the user loan application nodes, lending/processing entity nodes, and a AAS node (depicted in FIG. 4) of the computing system 100. Newly acquired loan application profile data, along with predicted outlook parameter data, may be recorded onto ledger 109 of blockchain 110 to serve as training data for predictive models such as the AAS 102 and ML module 240. That is, upon receiving a loan application from a user entity node, the AAS node retrieves financial data, normalizes it, and generates structured feature vectors capturing loan frequency, approval rates, and existing obligations. These vectors serve as ANN input, which computes predictive approval parameters and credit risk scores. The computed parameters are recorded onto the permissioned blockchain ledger, ensuring immutable, verifiable, and cryptographically signed entries. Smart contracts govern the storage and update of approval verdict parameters. When a borrower's financial status changes, such as submitting a new application or modifying an existing obligation, the system queries historical data from the blockchain, recalculates feature vectors, and updates borrower risk assessments accordingly. The updated approval parameters and risk profiles are appended to the blockchain, maintaining a comprehensive credit assessment history. Loan application reports containing approval recommendations, repayment capacity projections, and suggested terms are stored on the blockchain and are accessible to authorized financial institutions via controlled access protocols. The system employs smart contracts to validate borrower data across multiple institutions, preventing fraudulent loan stacking and enforcing consensus-driven approvals. By leveraging blockchain technology, the system enhances transparency, security, and compliance with data privacy regulations. In this way, the system may replace centralized credit repositories, allowing lenders to retrieve real-time borrower risk assessments directly from the blockchain, enabling faster, data-driven lending decisions.

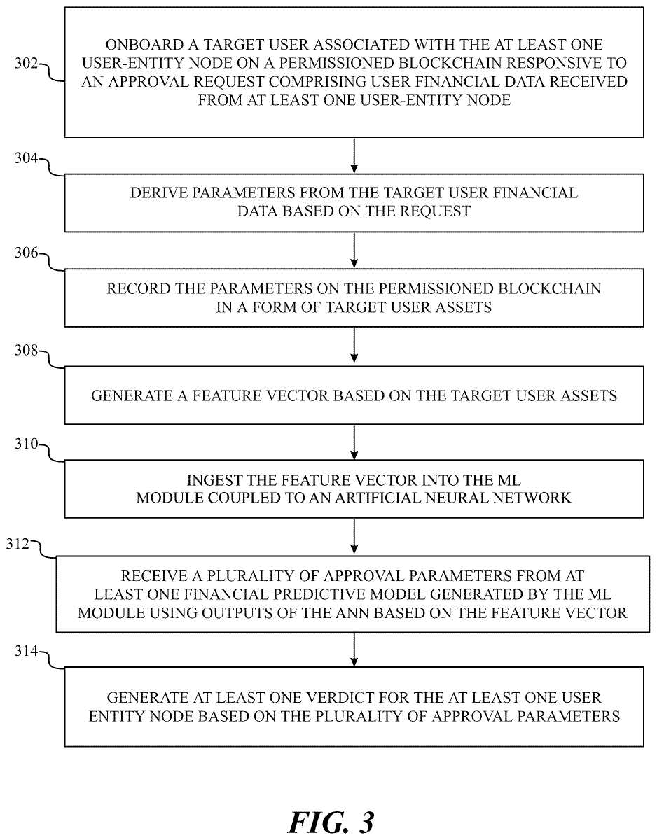

FIG. 3 illustrates a method for machine learning-based real-time analysis of loan application data with blockchain integration executed by the computing system of FIGS. 1 and 2. The method may include, in step 302, acquire target loan application data from the at least one target loan application node, the target loan application data comprising action metrics associated with loan applications submitted by the target loan application and the plurality of remote nodes related to the target loan application. In step 304, the system may perform normalization of the target loan application data based on the action metrics. In step 306, the system may parse the normalized data to derive a plurality of classifying features. In step 308, the system may generate a feature vector based on the plurality of classifying features. In step 310, the system may ingest the feature vector into the ML module coupled to an ANN. In step 312, the system may receive a plurality of approval verdict parameters from at least one loan application analysis predictive model generated by the ML module using outputs of the ANN based on the feature vector. In step 314, the system may generate at least one report or verdict for the at least one loan application node based on the plurality of approval verdict parameters.

FIG. 4 illustrates a network diagram of a system for machine learning-based real-time analysis of loan application data with blockchain integration consistent with the present disclosure. The depicted network 100′ includes an asset analysis server(AAS) node 102. The AAS node 102, along with the ML module 240, functions as described concerning FIG. 2, by obtaining target loan application data from at least one target loan application node (user entity 101 including, for example, a user loan application). This data comprises action metrics tied to loan applications submitted by the target loan application and various remote nodes associated with it. Additionally, the AAS node 102 may also gather user loan application-related data from external sources (not depicted). Such external data can include, but is not limited to, loan application records, live audio/video streams, imaging data, textual information, or a combination thereof. In certain embodiments, the raw data from loan application may be processed by the AAS node 102 utilizing pre-trained large language models (LLMs) or the ML module 240.

In another embodiment, the AAS node 102 can capture conversation data (e.g., call logs, audio, or textual exchanges) related to interactions between the user loan application 101, associated with user 111, and an AI agent 114. The AI agent 114 may function as a chatbot, supported by the AI/ML module 240 of the AAS node 102. The captured conversation data may include language identifier metadata, indicating the language used by user 111 while communicating with the AI agent 114.

The AAS node 102 can extract loan application data relevant to various loan application features from blockchain 110. Furthermore, it may retrieve pertinent remote historical loan application-related data and optimization data—such as previous outlooks, verdicts, reports, analysis, etc.—from blockchain 110 or a remote database 106. The remote historical data stored in database 106 may originate from multiple external sites and digital platform nodes linked to similar entities. These entities may share attributes such as jurisdiction, language, business size, ownership type, revenue, existing loans, and other related loan application 101 parameters.

The AAS node 102 is capable of normalizing target entity loan application data based on action metrics, parsing the normalized information to extract multiple classification features, and subsequently generating a feature vector or classifier data derived from loan application profile data and collected heuristic data. The heuristic data may include previously stored local historical loan application-related information. This feature vector or classifier data may then be fed into the AI/ML module 240. Using this data, the AI/ML module 240 constructs predictive models 108, which ultimately forecast loan application 101 outlook parameters. The outlook parameters of loan application 101 may be further analyzed by the AAS node 102 before generating the final verdict or recommendation reports 205. Once the user loan application 101 data undergoes complete processing through the AI/ML module 240, the predictive models 108 (such as the loan application outlook and loan application optimization predictive models) provide outputs, which are used to create a feedback report 205.

In one embodiment, the AAS node 102 may obtain loan application 101 profile data for outlook purposes from a permissioned blockchain 110 ledger 109. This occurs based on a consensus among the user loan application nodes 101, lending/processing entity nodes 113, and the AAS node 102. Additionally, confidential historical loan application-related data, previous entity-related data, and details pertaining to loan application outlook parameters can be sourced from the permissioned blockchain 110. Furthermore, newly acquired loan application profile data, along with predicted outlook parameter data, may be recorded onto ledger 109 of blockchain 110 to serve as training data for predictive models 108.

In this implementation, the AAS node 102, user entities 101, and loan application nodes 113 function as peer nodes within the blockchain 110. In some embodiments, data from the local database or remote database may be duplicated onto the blockchain ledger 109 to enhance security in storage.

The AI/ML module 240 is responsible for generating predictive models for loan application analysis and optimization, collectively identified as predictive models 108. These models derive approval verdict parameters for risk assessment and loan application 101 evaluation based on specific pre-stored data acquired from the blockchain 110 ledger 109. Consequently, the evaluation of loan application 101 is determined not only by current user loan application 101 data (i.e., loan application metrics) but also by historical heuristic data. This approach enables the final verdict and/or loan application 101 report 205 to be recorded on the permissioned blockchain 110 ledger 109. In this way, the system enables blockchain-based storage of loan application data, including continuously updating and storing approval verdict parameters and reports 205 in real-time on the blockchain 110 ledger 109. In some embodiments, upon completing the loan application 101 evaluation and report generation process, the associated documents may be converted into unique, secure NFT assets 403 and recorded on blockchain 110, ensuring their availability for future training of predictive models. In one embodiment, as a second phase of approval, a consensus mechanism within the blockchain may be implemented, requiring agreement among user entities and entities 113 before finalizing the loan application 101 and assessment report 205 generated by the AAS node 102.

The AAS node 102 is responsible for onboarding a target user associated with the user entity 101 onto the permissioned blockchain upon receiving an approval request containing user financial data. The AAS node 102 derives parameters from the target user financial data, including existing loans and pending loan applications, and records these parameters on the permissioned blockchain in the form of target user assets. This ensures that financial institutions have a decentralized and tamper-proof record of the user's financial status.

The AAS node 102 generates a feature vector based on the target user assets and ingests it into the ML module 240, which is coupled to an Artificial Neural Network (ANN). The ML module 240 utilizes this feature vector to generate a plurality of approval parameters through at least one financial predictive model. The predictive model refines its assessment by retrieving historical user-related data from the permissioned blockchain. This historical data includes past loan approvals, repayment histories, credit risk evaluations, and financial behaviors of similar entities. The system applies machine learning techniques to correlate the retrieved historical data with the target user's financial data, refining the approval decision-making process and ensuring risk-adjusted verdicts.

The AAS node 102 continuously monitors and queries the permissioned blockchain for incoming target user transactions to detect changes in the target user assets. This real-time monitoring allows the system to determine fluctuations in financial status, such as new loans acquired, changes in credit utilization, or additional financial commitments. If changes are detected, the AAS node 102 updates the feature vector accordingly and regenerates the approval parameters using financial predictive models. By employing dynamic adaptation techniques, the system ensures that approval verdicts are responsive to real-time financial data, improving the reliability of automated financial assessments.

Once an approval verdict is generated, the AAS node 102 compiles a target user approval report containing approval parameters, related recommendations, and a loan approval predicted verdict. This report is recorded on the permissioned blockchain ledger along with the corresponding feature vector, ensuring transparency, security, and auditability. Additionally, the system incorporates a consensus mechanism involving the entity node 101, the AAS node 102, and the plurality of remote nodes associated with the target user entity node. This consensus mechanism validates approval decisions and ensures that financial verdicts are derived from multiple data sources, reducing the likelihood of erroneous predictions.

The system further executes a smart contract to generate a Non-Fungible Token (NFT) corresponding to the loan approval report. The NFT securely encapsulates approval parameters, related recommendations, and the loan approval predicted verdict, providing an immutable and traceable record of the approval process. Additionally, the AAS node 102 may execute another smart contract to record the loan approval predicted verdict for the user entity node 101, along with the feature vector, onto the blockchain. This allows financial institutions and users to verify historical loan assessments and financial predictions without risk of data tampering.

The AAS node 102, user entities 101, and remote loan application nodes 113 operate as peer nodes within the blockchain network. In certain embodiments, data stored within a local or remote database may be duplicated onto the blockchain ledger 109 to enhance security and ensure redundancy. Additionally, the AAS node 102 may retrieve approval parameters from the permissioned blockchain in response to a consensus agreement among financial institutions, lending entities, and the target user entity node. This ensures that final approval decisions reflect aggregated inputs from multiple stakeholders rather than a single data source.

The AI/ML module 240 within the AAS node 102 plays a critical role in predictive decision-making by processing large volumes of financial data and dynamically adjusting approval verdicts based on updated transaction data. The system ensures compliance with financial regulations by maintaining immutable records of approval decisions, risk assessments, and recommendations on the blockchain. Additionally, the system's integration with smart contracts enables automated execution of approval processes, secure asset verification, and efficient financial transactions. This comprehensive approach ensures that financial institutions and users have access to a transparent, data-driven loan assessment platform that minimizes risk and maximizes predictive accuracy.

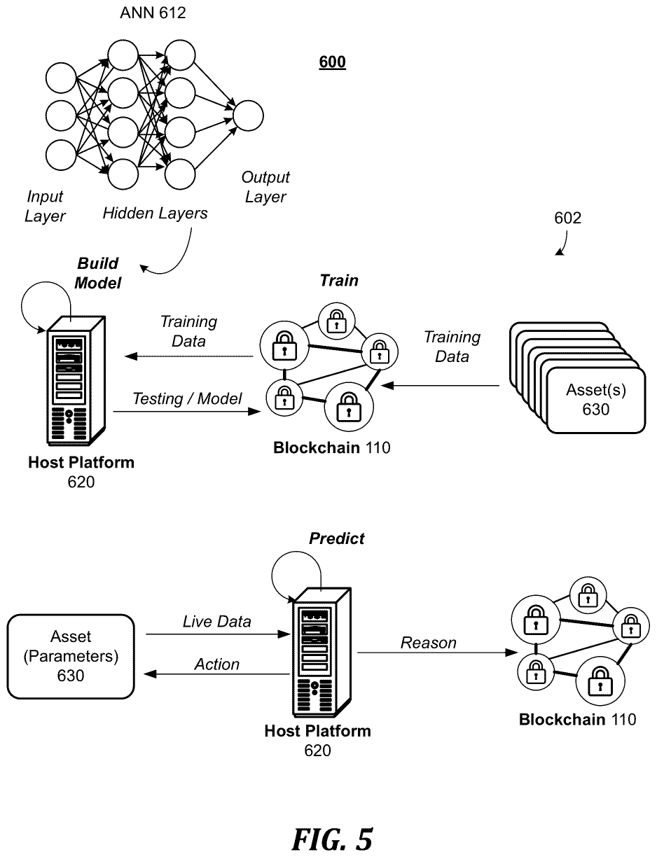

Referring to FIG. 5, a host platform 620 (such as the computing system 100 of FIG. 2 or AAS node 102 of FIG. 4) is responsible for building and deploying a machine learning model aimed at predictive monitoring of assets 630, such as the AAS 102 and ML module 240 of FIG. 2. The host platform 620 may encompass various types of computing environments, including a cloud platform, an industrial server, a web server, a personal computer, or a user device. Assets represent entity outlook and optimization parameters. The blockchain 110 enhances both the training process 602 of the ML module 240 and the predictive process 607 that utilizes outlook parameters derived from a trained model leveraging the outputs of the ANN 612. In 602, rather than requiring manual data collection by a data scientist, engineer, or other user, historical data (i.e., entity-related heuristics) may be stored directly by assets 630 themselves or via an intermediary (not shown) on the blockchain 110.

This approach significantly reduces the time required by the host platform 620 for predictive model training. By leveraging smart contracts, data can be securely and reliably transferred directly from its source (e.g., the AAS 102 of FIG. 2 or database 150 depicted in FIG. 1) to the blockchain 110. The blockchain 110 ensures data security and ownership while enabling smart contracts to facilitate direct data transmission from assets to entities utilizing it for ML module 240 development. This structure supports data sharing among assets 630. The collected data is stored on the blockchain 110 via a consensus mechanism, which includes permissioned nodes that verify and ensure the accuracy of recorded data. This recorded data is time-stamped, cryptographically signed, immutable, and thus remains auditable, transparent, and secure.

Additionally, training and refining the ML module 240 using the collected data involves multiple iterations by the host platform 620. Each iteration incorporates additional or previously unconsidered data to enhance the model's knowledge. In 602, different training and design steps, along with their associated data, can be stored on the blockchain 110 by the host platform 620. Modifications in variables, weights, and other parameters during model refinement are also recorded on the blockchain 110. This process provides verifiable proof of how the model was trained and what data contributed to the training. Once the host platform 620 finalizes the trained model, it can be stored on the blockchain 110 as well.

After training, the ML module 240 is deployed in a live environment where it generates predictions and decisions based on its execution and predictive parameters. In this example, data fed back from asset 630 is input into the model to generate approval verdict parameters based on recorded entity-related data. Any determinations made by executing the ML module 240 such as approval of approval verdict parameters and evaluation reports—are recorded on the blockchain 110, ensuring verifiability and auditability. As a specific example, the model may predict a future modification or replacement of a component of asset 630 (i.e., evaluating digital entity metrics). The data supporting this decision is stored by the host platform 620 on the blockchain 110.

### Example Use Cases

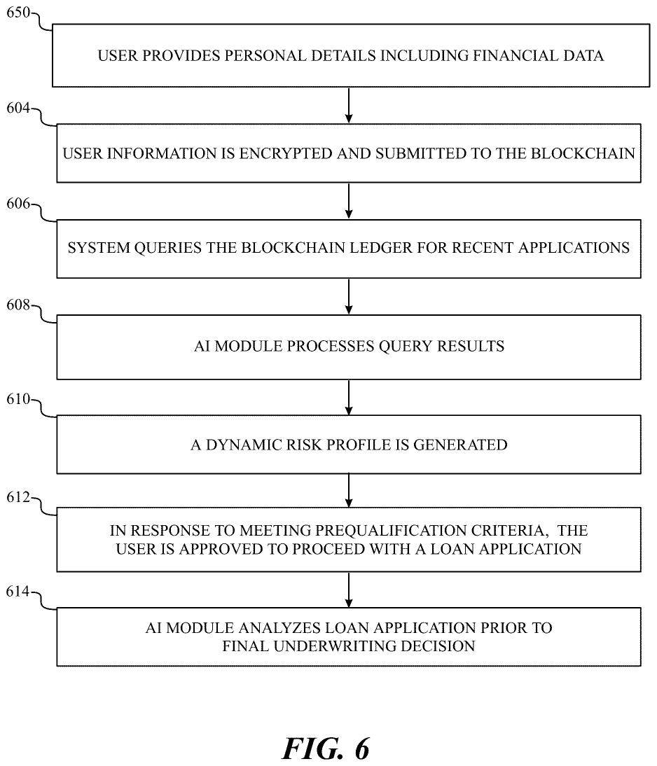

FIG. 6 depicts an example of a method of conducting loan prequalification, according to embodiments. In step 650, a user provides personal details, such as financial data or loan application data to the system. In step 604, the system encrypts user information and submits encrypted user information to the blockchain. In step 606, the system queries the blockchain Ledger for recent applications associated with the same user. In step 608, the AI module processes the query results. In step 610, the system generates a dynamic risk profile of the user based on data associated with the user. In step 612, in response to meaning pre-qualification criteria, the system may approve the user to proceed with submission of a loan application. In step 614, the AI module analyzes a user submitted loan application prior to submitting the loan application to a final underwriting decision. Hmm

As a non-limiting example of conducting loan prequalification via the system, John needs an $800 short-term loan for a car repair. At ABC Store, he provides his personal details, which may be encrypted and submitted to the blockchain through an API integration. The system queries the system's global blockchain ledger to verify whether John has recently applied for other loans. The system's AI module processes the query results in real-time, ensuring no applications exist within the last 48 hours. Because John meets prequalification criteria the system generates a dynamic risk profile and approves him to proceed with a full loan application. John's application may be then analyzed using the ANN model before the final underwriting decision.

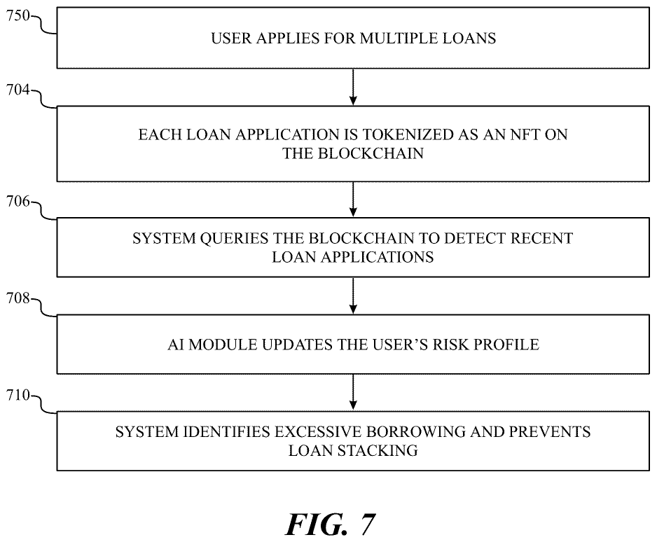

FIG. 7 depicts an example of a method of conducting multiple loan stacking prevention, according to embodiments. In step 750, a user applies for multiple loans. In step 704, each loan application submitted by the user is tokenized as an NFT on the blockchain. In step 706, the system queries the blockchain to detect recent additional loan applications. In step 708, the AI module updates the user's risk profile based on detected recent loan applications. In step 710, the system identifies excessive borrowing based on the user's risk profile and prevents loan stacking.

As a non-limiting example of conducting multiple loan stacking prevention via the system, Steve frequently applies for short-term loans from multiple lenders. Because traditional systems do not track real-time applications, Steve can secure multiple loans on the same day. However, using the system's blockchain-enabled tracking, Steve's loan applications may be tokenized as NFTs within seconds of submission. When a second lender queries the database, the AI module flags Steve's recent loan attempts and updates his risk profile accordingly. In response, the system detects potential overleveraging and prevents excessive borrowing, reducing default risks.

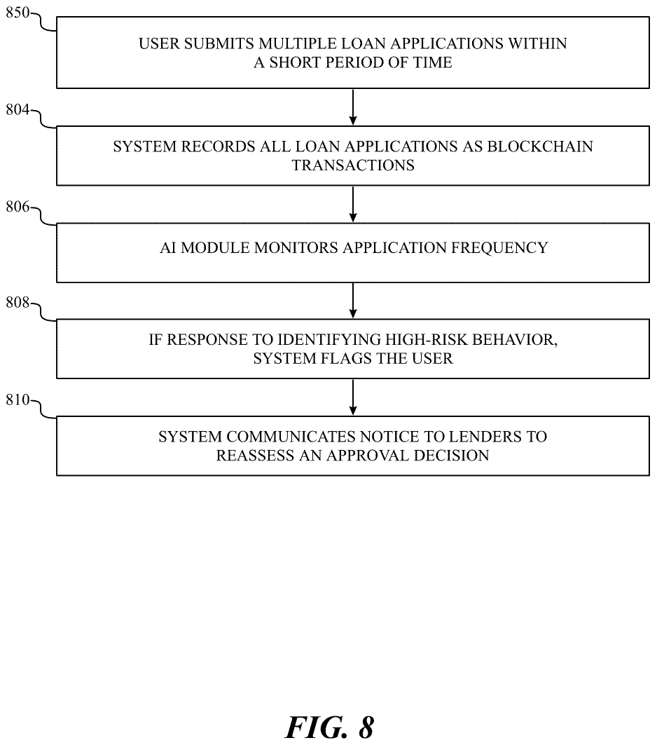

FIG. 8 depicts an example of a method of analyzing overlapping loan applications, according to embodiments. In step 850, a user submits multiple loan applications within a relatively short period of time. In step 804, the system records the submitted loan applications as blockchain transactions. In step 806, the AI Module monitors application submission frequency. In step 808, if a response is detected identifying high risk behavior, such as based on high application submission frequency the system flags the user. In step 810, the system communicates a notice to lenders to reassess approval decisions based on high-risk behavior.

As a non-limiting example of analyzing overlapping loan applications via the system, Sally applies for three loans within 30 minutes, stating she has no existing debts. Since traditional credit systems lack real-time reporting, all three lenders approve her application. The system prevents this issue by instantly recording Sally's loan attempts as blockchain transactions. The AI engine monitors her application frequency and flags her behavior as high-risk, allowing lenders to reconsider approval before funds may be disbursed. In this way, the system prevents Sally from securing unmanageable debt.

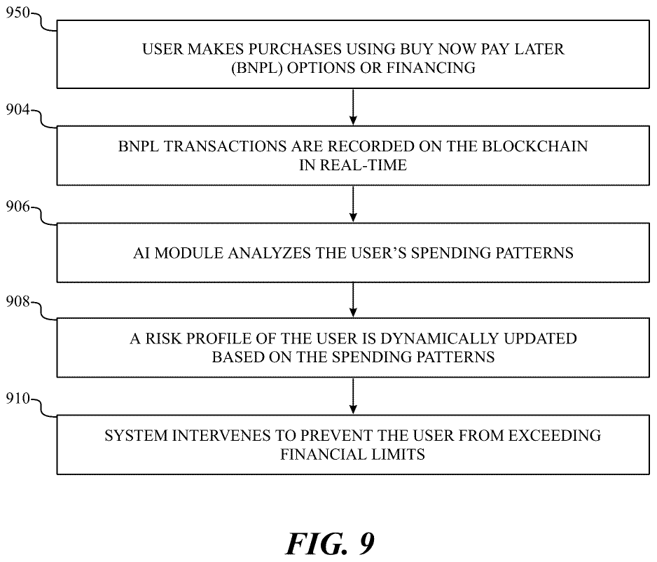

FIG. 9 depicts an example of a method of preventing overspending via Buy Now Pay Later (BNPL) arrangements, according to embodiments. In step 950, a user makes purchases using BNPL options or financing. In step 904, BNPL transactions are recorded on the blockchain in real time. In step 906, the AI module analyzes the user spending patterns. In step 908, a risk profile of the user is dynamically updated based on the spending patterns. In step 910, the system intervenes to prevent the user from exceeding financial limits.

As a non-limiting example of preventing overspending via BNPL arrangements via the system, Jerry shops online using BNPL options but unknowingly overextends himself. Traditional BNPL systems lack real-time interconnectivity, approving multiple purchases without assessing his total financial obligations. The system's live blockchain tracking ensures each BNPL transaction may be immediately recorded and visible to participating merchants. The AI model detects potential overleveraging and updates Jerry's risk profile, preventing him from exceeding his financial capacity.

### Additional Example Use Case Examples

Instant Loan Data Capture & NFT Tokenization: Every loan application may be immediately recorded as an NFT token on the system's blockchain. The AI/ML module continuously analyzes and reports on these tokens in real-time.

Industry-Specific Reporting & Customization: The system offers fully modular, flexible reports tailored to specific industries, ensuring compliance with varied financial regulatory requirements.

Elimination of Account History Reconciliation: Storing historical loan data as blockchain tokens eliminates complex reconciliations, as every data point may be timestamped and securely maintained.

Blind Spot Prevention with Live Data: Traditional credit agencies experience delays in data updates. The system's real-time blockchain tracking eliminates blind spots, ensuring all loan applications may be immediately captured.

Competitive Differentiation: Existing credit reporting systems lack the system's instant data recording and AI-driven risk profiling, providing a significant advantage in fraud prevention and lending accuracy.

In this disclosure, the various embodiments may be described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks may be performed by remote processing devices that may be linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related loan application or a loan application related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which may be operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as may be used herein means software other than the operating system, such as Word processors, database managers, Internet browsers and the like. Each application generally has its own user interface, which allows a user to interact with a particular program. The user interface for most operating systems and applications may be a graphical user interface (GUI), which uses graphical screen elements, such as windows (which may be used to separate the screen into distinct work areas), icons (which may be small images that represent computer resources, such as files), pull-down menus (which give a user a list of options), scroll bars (which allow a user to move up and down a window) and buttons (which can be “pushed” with a click of a mouse). A wide variety of applications may be known to those in the art.

The phrases “Application Program Interface” and API as may be used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API may be also used by hardware devices that run software programs. The API generally makes a programmer's job easier, and it also benefits the end user since it generally ensures that all programs using the same API will have a similar user interface.

The phrases “computing device” or “central processing unit” as may be used herein means a computer hardware component that executes individual commands of a computer software program. It reads program instructions from a main or secondary memory and then executes the instructions one at a time until the program ends. During execution, the program may display information to an output device such as a monitor.

The term “execute” as may be used herein in connection with a computer, console, server system or the like means to run, use, operate or carry out an instruction, code, software, program and/or the like.

In this disclosure, the descriptions of the various embodiments have been presented for purposes of illustration and may be not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment may be not limited to what has been particularly shown and described hereinabove. A variety of modifications and variations may be possible considering the above teachings without departing from the following claims.

What is claimed is:

1. A system for an automated real-time analysis and generation of predictive verdict for a user entity based on user entity blockchain assets, comprising:
a processor of an asset analysis server (AAS) node configured to host a machine learning (ML) module coupled to at least one user-entity node and to a plurality of remote nodes associated with the at least one user-entity node over a permissioned blockchain network; and
a memory on which are stored machine-readable instructions that when executed by the processor, cause the processor to:
onboard a target user associated with the at least one user-entity node on a permissioned blockchain responsive to an approval request comprising user financial data received from at least one user-entity node;
derive parameters from the target user financial data based on the request;
record the parameters on the permissioned blockchain in a form of target user assets;
generate a feature vector based on the target user assets;
ingest the feature vector into the ML module coupled to an Artificial Neural Network (ANN);
receive a plurality of approval parameters from at least one financial predictive model generated by the ML module using outputs of the ANN based on the feature vector; and
generate at least one verdict for the at least one user entity node based on the plurality of approval parameters.

2. The system of claim 1, wherein the target user assets comprising any of:
existing loans of the target user; and
pending loan applications of the target user.

3. The system of claim 1, wherein the machine-readable instructions that when executed by the processor, cause the processor to:
query the permissioned blockchain to retrieve historical users-related data based on the plurality of the on the target user assets; and
generate a feature vector based on the plurality of the target user assets and the historical entity-related data.

4. The system of claim 1, wherein the machine-readable instructions that when executed by the processor, cause the processor to continuously monitor on the permissioned blockchain incoming target user transactions to determine changes in the target user assets.

5. The system of claim 4, wherein the machine-readable instructions that when executed by the processor, cause the processor to, responsive to the changes in the target user assets, generate an updated feature vector based on the incoming target user transactions and generate at least one approval parameter produced by the at least one financial predictive model in response to the updated feature vector.

6. The system of claim 1, wherein the machine-readable instructions that when executed by the processor, further cause the processor to generate a target user approval report comprising approval parameters and related recommendations and a loan approval predicted verdict.

7. The system of claim 6, wherein the machine-readable instructions that when executed by the processor, further cause the processor to record the approval parameters, and the related recommendations and a loan approval predicted verdict on a permissioned blockchain ledger along with the at least one feature vector.

8. The system of claim 7, wherein the machine-readable instructions that when executed by the processor, further cause the processor to retrieve at least one approval parameters from the permissioned blockchain responsive to a consensus among the at least one entity node, the AAS node and the plurality of the remote nodes associated with the at least one target entity node onboarded onto the permissioned blockchain.

9. The system of claim 6, wherein the machine-readable instructions that when executed by the processor, further cause the processor to execute a smart contract to generate at least one NFT corresponding to the target entity loan approval report comprising approval parameters and related recommendations, and a loan approval predicted verdict.

10. The system of claim 6, wherein the machine-readable instructions that when executed by the processor, further cause the processor to execute a smart contract to record the loan approval predicted verdict for the at least one user entity node along with the feature vector.

11. A computer-implemented method comprising:
onboarding, via a computing device, a target user associated with the at least one user-entity node on a permissioned blockchain responsive to an approval request comprising user financial data received from at least one user-entity node;
deriving, via the computing device, parameters from the target user financial data based on the request;
recording, via the computing device, the parameters on the permissioned blockchain in a form of target user assets;
generating, via the computing device, a feature vector based on the target user assets;
ingesting, via the computing device, the feature vector into the ML module coupled to an Artificial Neural Network (ANN);
receiving, via the computing device, a plurality of approval parameters from at least one financial predictive model generated by the ML module using outputs of the ANN based on the feature vector; and
generating, via the computing device, at least one verdict for the at least one user entity node based on the plurality of approval parameters.

12. The method of claim 11, wherein the target user assets comprising any of:
existing loans of the target user; and
pending loan applications of the target user.

13. The method of claim 11, further comprising:
querying the permissioned blockchain to retrieve historical users-related data based on the plurality of the on the target user assets; and
generating a feature vector based on the plurality of the target user assets and the historical entity-related data.

14. The method of claim 11, further comprising continuously monitoring the permissioned blockchain incoming target user transactions to determine changes in the target user assets.

15. The method of claim 14, further comprising, responsive to the changes in the target user assets, generating an updated feature vector based on the incoming target user transactions and generate at least one approval parameter produced by the at least one financial predictive model in response to the updated feature vector.

16. The method of claim 11, further comprising generating a target user approval report comprising approval parameters and related recommendations and a loan approval predicted verdict.

17. The method of claim 16, further comprising recording the approval parameters, and the related recommendations and a loan approval predicted verdict on a permissioned blockchain ledger along with the at least one feature vector.

18. The method of claim 17, further comprising retrieving at least one approval parameters from the permissioned blockchain responsive to a consensus among the at least one entity node, the AAS node and the plurality of the remote nodes associated with the at least one target entity node onboarded onto the permissioned blockchain.

19. The method of claim 16, further comprising executing a smart contract to generate at least one NFT corresponding to the target entity loan approval report comprising approval parameters and related recommendations, and a loan approval predicted verdict.

20. The method of claim 16, further comprising executing a smart contract to record the loan approval predicted verdict for the at least one user entity node along with the feature vector.
